(19) United States
(12) Patent Application Publication
(10) Pub. No.: US 2012/0042259 A1
(43) Pub. Date: Feb. 16, 2012

(54) WebConnect: Website for increasing ease of website and media accessiblity on the world wide web

(76) Inventor: Ezana Berhane, South Riding, VA (US)

(21) Appl. No.: 12/854,509

(22) Filed: Aug. 11, 2010

(51) Int. Cl. G06F 15/16; G06F 3/00

(52) U.S. Cl. 715/739

(57) ABSTRACT

WebConnect is a collection of methods combined onto one website. These methods include: an advanced bookmarking method, a social network, time-management tools, a personal media, and simple mail transfer protocol tool. WebConnect allows easy access to websites, specifically those that require accounts with passwords. When a user has bookmarked a website, websites over an https require you to log in; even when the user has exercised the option of having the browser remember the username and password. The application provided by WebConnect gives the user the option of saving the website in memory even while logged in. So the next time the user wants to visit that specific web page, they can simply navigate to the website without signing in. This application is referred to as trapping, and it is the central part of WebConnect that eliminates having to memorize various logins. In the context of a website, to trap means to save any page on an open account, or any page in general, for later access to avoid having to sign in later.

### BACKGROUND OF THE INVENTION

1. Field of the Invention

The present invention operates as a website on the World Wide Web, providing the service of effortless navigation between the various objects user's of the World Wide Web encounter such as websites and media; specifically documents, videos, and images of all formats.

2. Description of the Related Art

In the vast frontier of the World Wide Web that millions of people operate on, many people open accounts on websites. As time goes on, the numbers of websites people open accounts on continue to grow exponentially; making it increasingly difficult to remember the usernames and passwords for everyone. The main purpose of this invention is to provide a means to make connecting to all the websites with usernames and passwords effortless.

### BRIEF SUMMARY OF THE INVENTION

The name of this invention is WebConnect, and its main feature is easy access to websites, specifically those that require accounts with passwords. Although this method sounds similar to the idea of bookmarking a website, there is a significant difference. When a user has bookmarked a website, websites over an https require you to log in; even when the user has exercised the option of having the browser remember the username and password. The application provided by WebConnect gives the user the option of saving the website in memory even while logged in. So the next time the user wants to visit that specific web page, they can simply navigate to the website without signing in. This application is referred to as trapping, and it is the central part of WebConnect that eliminates having to memorize various logins. In the context of a website, to trap means to save any page on an open account, or any page in general, for later access to avoid having to sign in later.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is an example of a simple SpiderWeb in which there is one web that is themed to connect to the user's trapped social networks. If the user selects any of the icons on the SpiderWeb they will be led to the page that they trapped, whether logged in or not.

FIG. 1B is an example of a complex SpiderWeb in which there is one SpiderWeb for all of the user's sources of entertainment. Each of the branches of this “Entertainment” SpiderWeb are all converted into sub-SpiderWebs when selected.

FIG. 1C is an example of a sub-SpiderWeb of the parent SpiderWeb “Entertainment”. The example in the figure is the “Video Websites” branch of FIG. 1B, and when selected becomes a simple SpiderWeb displaying the user's trapped websites for that web.

FIG. 1D is a SpiderWeb of the user's media, their personal media being the “Documents”, “Images”, and “Videos” branches and media imported from their friend's accounts on the “Shared” branch.

FIGS. 1E-1H are all examples of the sub-SpiderWebs of the parent “Media” SpiderWeb. In FIGS. 1E-1G it is evident that a SpiderWeb is not limited to be either simple or complex but can be both. The first three branches of each sub-SpiderWeb are simple because they only display one media while every fourth branch is a complex branch that contains a sub-SpiderWeb. FIG. 1H is the “Shared” sub-SpiderWeb of the parent “Media” SpiderWeb.

FIG. 2A is an example of trapping a website without signing into the website. In this example, the popular website “facebook.com” is visited, and the user has decided to trap this page. The main feature of the trap method has not been executed because the user has not signed in.

FIG. 2B is an example of trapping a website while signed into the website. In this example the user has signed into their Facebook account and is currently on their home page. If the user was to trap this specific page and place it on a SpiderWeb, the next time they access this specific page via the SpiderWeb, this will be the exact page they will be sent to. The user will not be prompted to login manually or by pressing the login button if the browser remembers the username and password.

FIG. 3A is the first instance of the locker application. While the user is entering their username and password to sign into their WebConnect account, there will be a locker dial for the user to enter their six-digit combination(s) if created.

FIG. 3B includes the second and third instances of the locker application. In the second instance, the user has placed a locker dial on their SpiderWeb titled “Financial”. While the user is free to access their “Social Networks” SpiderWeb, they must enter the six-digit combination(s) they have created for the “Financial” SpiderWeb. In the third instance, notice the tiny square in the upper right hand corner of the window below the address bar. That tiny square is symbolic of an ice cube and clicking on it freezes the users account. When the user selects the ice cube, all websites that have been opened via WebConnect including the WebConnect website will be frozen (temporarily inaccessible) and eventually logged out of if the icebreaker is not entered within a certain period of time. The icebreaker is the six-digit combination(s) that user must enter in the locker dial in order to unfreeze there account. If the incorrect icebreaker is entered too many times the account automatically logs out. The user's account and opened websites are automatically frozen after a certain period of inactivity and eventually logged out of if the icebreaker is not entered.

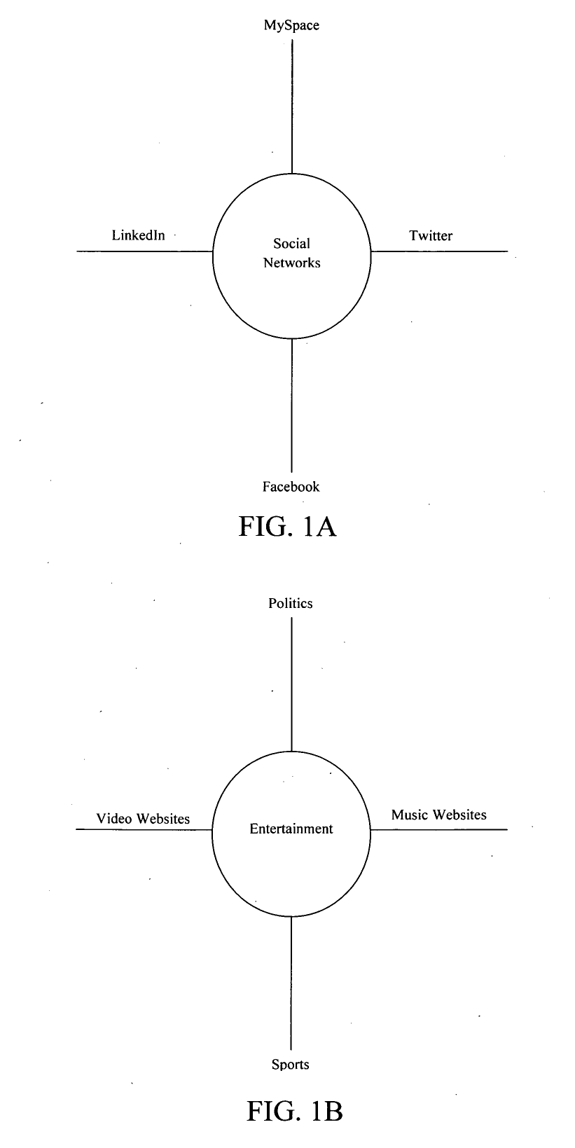

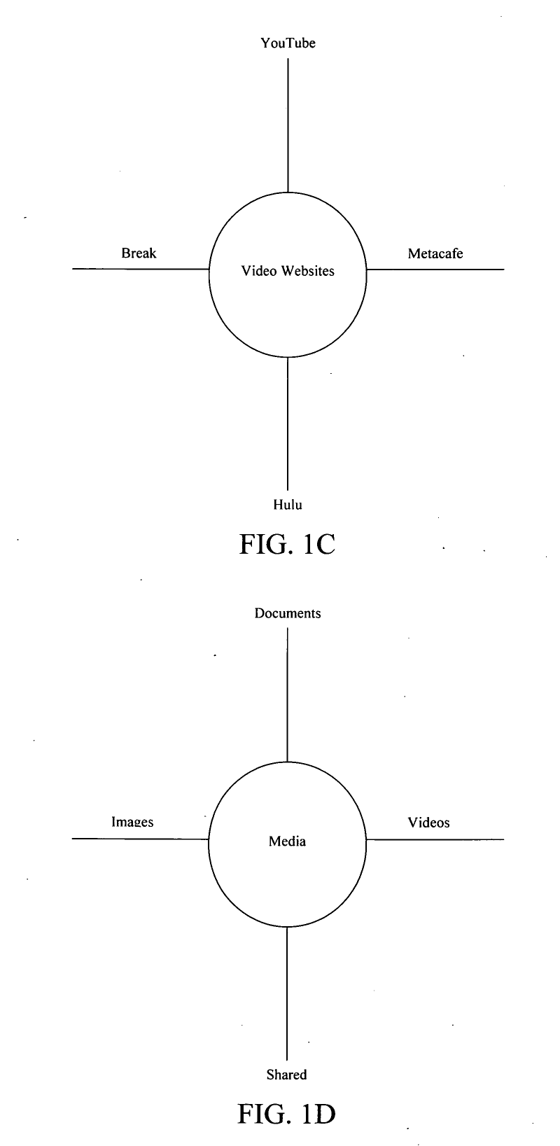

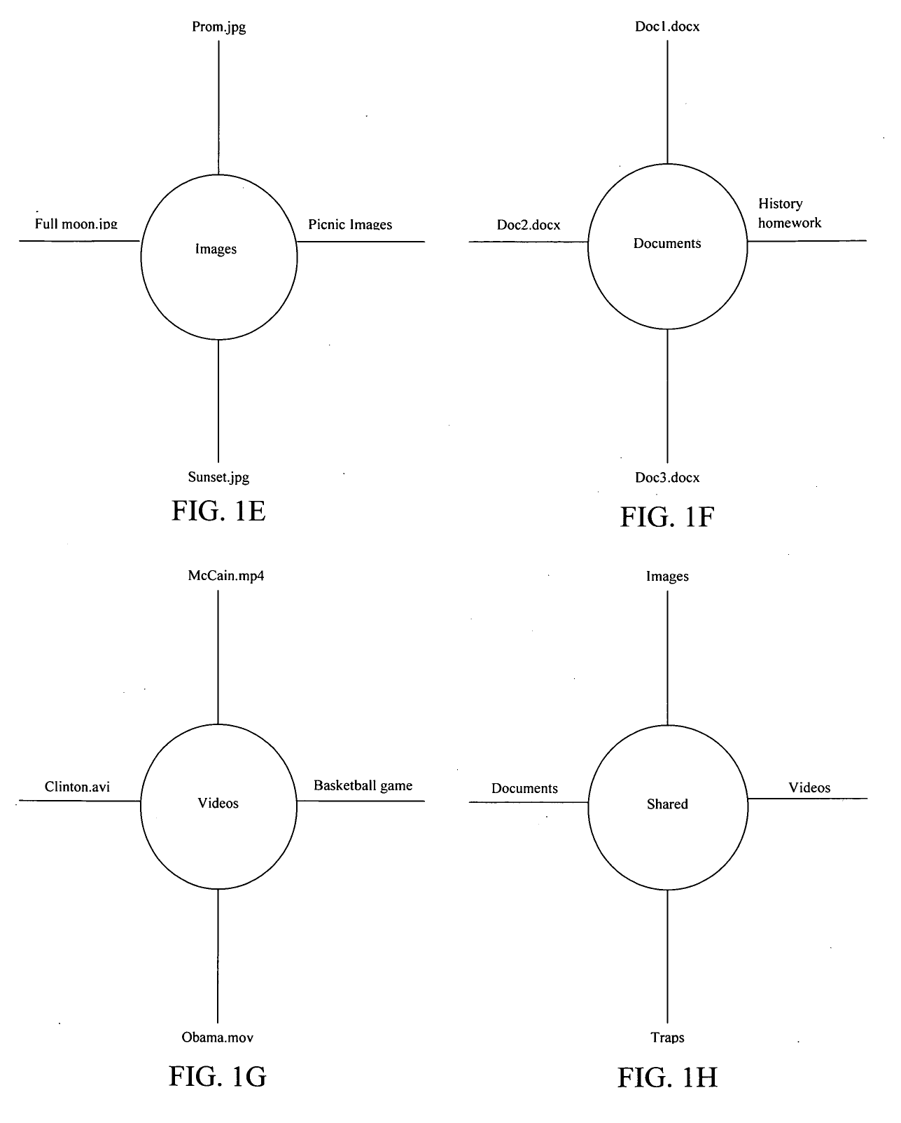

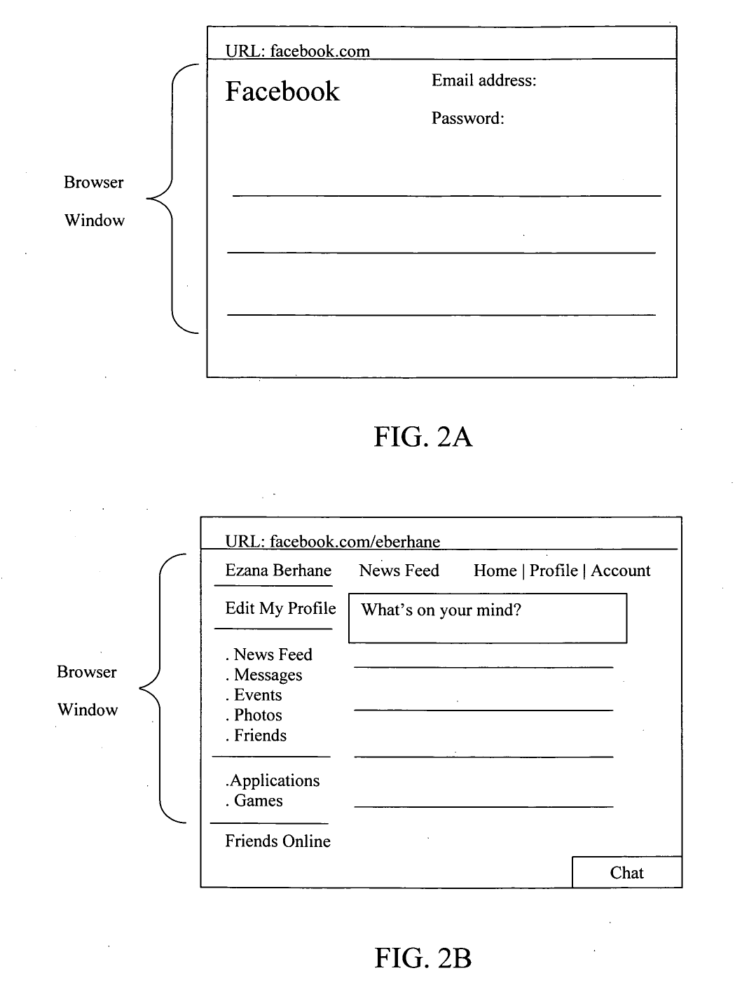

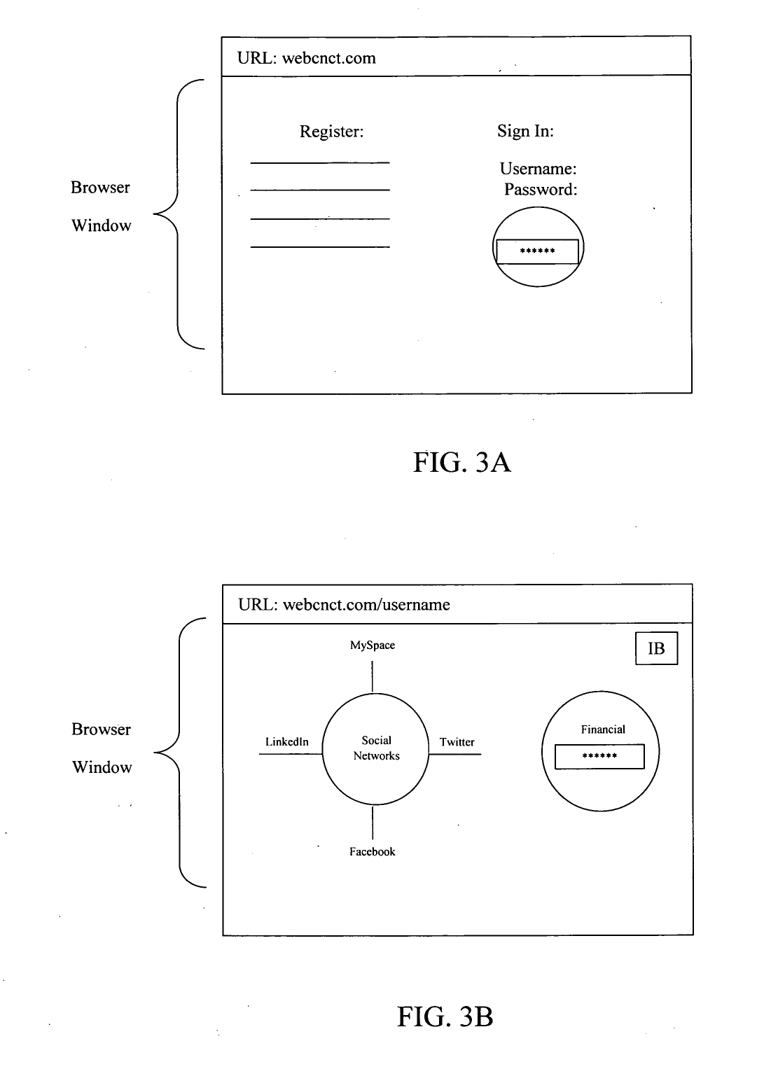

### DETAILED DESCRIPTION OF THE INVENTION

According to the embodiment of the invention, there is provided an application that enables World Wide Web users to organize their websites and media in a manner that enables them to revisit those websites in a timely and efficient manner via trapping. Trapping is similar to bookmarking in providing a reference link to a web page, with the exception that it is not bound solely by websites and media that are not logged into a users account.

Additionally, a media embodiment enables every user to upload their own personal media to their account such as documents, pictures, and videos and organize them so that they and their friends may access and share the media when convenient.

A further embodiment enables WebConnect users to effectively organize their trapped websites. WebConnect provides an interactive tool that provides the organizational mean by which the user refers to once they have trapped a website. This tool is referred to as a SpiderWeb, and the SpiderWeb gathers information from the source of the trap and displays it so that the user may easily navigate to a trapped link.

Further embodiments of the invention enable its users to stay in touch with other WebConnect users via a social network setup within the website enabling the user to add friends and communicate with them via the various methods on WebConnect. The first aspect of the social network consists of a chat house, and a chat house is capable of managing up to eight chat rooms at once. Each chat room enables the user to chat with up to seven of their friends at once. Each chat room additionally has a media tool that enables users in the chat room to view websites and personal media with each other while chatting. The second aspect enables the user to form a blog and to keep track of all of their favorite blogs that either their friends create or blogs that are made public on WebConnect. The third aspect has a sub-division of two more embodiments. The first embodiment enables the user to send friend request and organize their friend list. The second embodiment of the third aspect enables a group of WebConnect users to share one account for a common purpose. The initial creator of the account has ultimate authority of control and is able to make the most changes to the account, invite people to join the account, and deny people membership to the account. Overtime, as the number of accounts that join the shared account grows, referred to as a colony, the account creator may choose to distribute the authority of control to other members of the colony.

In yet another embodiment, there is an application that keeps the user updated on various items and media of interest that are updated on WebConnect. This application also keeps the user updated an the social aspect of WebConnect by showing the user any chat requests sent to them.

An additional aspect of this application enables the user to keep track of how many of a certain tab or window the user would like to open in their respective browser.

From a security perspective, there is a secure embodiment of WebConnect that increases the user's personal security. The secure application that protects the user's security operates similar to that of a rotating lock used to protect personal items in a locker. The user has the option of applying a six digit combination in addition to entering their username and password when they are in the process of logging into their account. Although every combination needs to be six digits, the user may enter as many combinations as they like. This combination method may be applied to SpiderWeb's the user would like to protect as well. The combination method may also appear under two more conditions, if the account has been inactive for a certain period of time or if the user needs to step away from their computer for a moment. The users account is temporarily frozen, but not logged out of until a certain period of inactivity is reached. If the user chooses to temporarily freeze their account, all media and web pages that have been opened via WebConnect will be frozen, and the user must enter as many six digit combinations as they have assigned in order to unfreeze their account.

What is claimed is:

1. A WebConnect website comprising a series of methods, the method comprising:
A. The trap enables the user to quickly refer to specific types of websites on the web by storing html code of any website in memory for later reference;
B. The method including websites that require a username and password to arrive at the page;

2. The method of claim 1,
Comprising an application called the SpiderWeb;
A. The SpiderWeb operates as a series of branches; the depth and variety of each branch to be determined by the user;
B. The SpiderWeb organizes and displays trapped websites, along with the user's personal media and media they have selected from their friends or colonies, referred to as shared media, including the friends or colonies trapped websites;
C. Each branch capable of containing one or more of various trapped websites or personal/shared media;
D. The user accesses the websites and media via the Spider Web by hovering over the icon presented by the website or media displayed;
E. The SpiderWeb method is able to form a SpiderWeb of all Bookmarks stored in the user's web browser and organize the bookmarks and their folders on the SpiderWeb according to the user's preference;
F. The user chooses to export a SpiderWeb to their computer desktop where they are able to access their trapped websites and media on the said SpiderWeb, wherein the security methods of claim 4 apply.

3. A WebConnect comprising a series of methods, comprising:
A. A Social Web enabling the user to stay connected to their friends with WebConnect accounts;
B. Wherein the Social Web gives the user three options: Chat, Blog, and Network;
C. Wherein the method comprises a Chat option by which the user is displayed a chat house, enabling the user to chat with their fellow peers up to eight chat rooms;
D. Wherein every chat room, the user communicates with up to seven of their friends with WebConnect accounts;
E. Wherein every chat room having a media tool that acts as a web browser, media player, document viewer, and image viewer enabling all members of the chat room to view the same websites and media;
F. The method further comprising a colony application which enables a group of friends to all operate one account;

4. The WebConnect website comprising of a series of methods, the next method being a security method comprising:
A. The locker application for security measuring where the user must enter a six digit combination in order to advance to another page;
B. Wherein the user can apply the method as many times as they want in one instance;
C. Wherein the method is to be applied in the process of the instance when the user is signing in their username and password;
D. Wherein the method may be applied to the SpiderWeb;
E. Wherein the method may occur under two more conditions; manually and automatically;
F. Wherein if the user decides to manually apply the method in the context of their account as a whole, this method is referred to as freezing the account, and the users account is temporarily frozen and they must reenter the number of six digit combinations they have created for the frozen instance to re-access their account, and if the user fails to reenter the combination after a certain period of time, the account automatically logs out; and,
G. Wherein the method will occur automatically in the context of the account as a whole if the account is inactive after a certain period of time, and the user must reenter the number of six digit combinations in order to unfreeze their account, and if the user fails to reenter the combination after a certain period of time, the account automatically logs out.

5. The WebConnect method comprising:
A. The track bar application for updating the WebConnect user's certain items of interest and activity;
B. The method originally updates the user on default items such as the Social Web, Mail, Calendar, and Media applications;
C. Wherein the user has the option of using a word processor to enter text or paste images to save for later access;
D. Wherein the user has the option of editing their items so they can either remove the default items and receive frequent information about updates to other items such as blogs or colonies;
E. Wherein the method also comprises of a tab/windows track application that lists the URL addresses within the tabs and windows of the users web browsers;
F. Wherein the application gives the user the option of opening the user's specified URL addresses in as many new tabs and/or windows as they input.
